(19) United States
(12) Patent Application Publication
(10) Pub. No.: US 2021/0337051 A1
(43) Pub. Date: Oct. 28, 2021

(54) MOBILE TERMINAL

(71) Applicant: WUHAN CHINA STAR OPTOELECTRONICS TECHNOLOGY CO., LTD., Wuhan, Hubei (CN)

(72) Inventor: Wei ZHANG, Wuhan, Hubei (CN)

(21) Appl. No.: 16/343,823

(22) PCT Filed: Dec. 29, 2018
(86) PCT No.: PCT/CN2018/125226

§ 371 Date: Apr. 22, 2019

(30) Foreign Application Priority Data
Nov. 23, 2018 (CN) 201811402892.2

(51) Int. Cl. H04M 1/02

(52) U.S. Cl. CPC H04M 1/0266

(57) ABSTRACT

A mobile terminal includes a middle frame, a display module, and a cover plate. The middle frame includes a first placement slot and a second placement slot. The display module is disposed in the second placement slot. The cover plate is disposed in the first placement slot. The display module includes a fixing frame. The fixing frame includes first sidewalls. An extending direction of the first sidewalls is perpendicular to an extending direction of two end areas of the first placement slot. The first sidewalls each include an upper surface facing the cover plate. Two sides of the cover plate and the upper surface of each of first sidewalls are fixedly connected.

### FIELD OF INVENTION

The present disclosure relates to the field of display technologies, and more particularly to a mobile terminal.

### BACKGROUND OF INVENTION

In current mobile phones, as illustrated in FIG. 1, a mobile phone includes a middle frame 10′, a display module 20′, and a glass cover 30′. An inner edge of the middle frame 10′ is provided with a step. The lower portion of the step is closed to form a first placement slot 12′. The upper portion of the step is closed to form a second placement groove 11′. The first placement slot 12′ is in communication with the second placement slot 11′. The display module 20′ is disposed in the first placement slot 12′. There is a gap between the display module 20′ and the lower portion of the step, and a width of the gap is 0.3 mm. The glass cover 30′ is disposed in the second placement slot 11′, and an overlapping width D1′ of the glass cover 30′ and the step ranges between 0.6 mm and 0.8 mm or more. Therefore, a distance from the display module 20′ to an inner wall of the second placement slot 11′ of the middle frame 10′ ranges between 0.9 mm and 1.1 mm.

As a result, a screen ratio of the mobile phone cannot be increased.

### SUMMARY OF INVENTION

An embodiment of the present disclosure provides a mobile terminal to solve the technical problem that current mobile phones have a relatively small screen ratio.

An embodiment of the present disclosure provides a mobile terminal. The mobile terminal includes a middle frame, a display module, and a cover plate. The middle frame includes a first placement slot and a second placement slot. The first placement slot includes an intermediate area and two end areas positioned at two ends of the intermediate area, the second placement slot is positioned below the intermediate area and communicates with the intermediate area, a peripheral edge of the intermediate area and a peripheral edge of the second placement slot are coincident. The display module is disposed in the second placement slot. The cover plate is disposed in the first placement slot. The display module includes a fixing frame, a backlight module, and a display panel, and the backlight module and the display panel are both disposed in the fixing frame. The fixing frame includes opposite first sidewalls, an extending direction of the first sidewalls is perpendicular to an extending direction of the two end areas, and the first sidewalls each include an upper surface facing the cover plate. Two sides of the cover plate and the upper surface are fixedly connected. The upper surface and bottom surfaces of the two end areas of the first placement slot are flush. The first sidewalls each are further provided with a support strip with rigidity, and an extending direction of the support strip is same with the extending direction of the first sidewalls.

In an embodiment of the present disclosure, the upper surface and the bottom surfaces of the two end areas define a connecting surface, and a peripheral edge portion of the cover plate is fixedly connected to the connecting surface by a foam adhesive.

In an embodiment of the present disclosure, a width of each of the first sidewalls ranges between 0.4 mm and 0.5 mm.

In an embodiment of the present disclosure, the fixing frame further includes opposite second sidewalls, an extending direction of the second sidewalls is parallel to an extending direction of the two end areas, and a width of each of the second sidewalls is less than a width of each of the first sidewalls.

In an embodiment of the present disclosure, the second sidewalls are positioned at a level lower than or equal to a level of the bottom surfaces of the two end areas.

In an embodiment of the present disclosure, the fixing frame includes a first fixing slot and a second fixing slot, the first fixing slot includes an intermediate portion and an edge portion positioned around the intermediate portion, the second fixing slot is positioned below the intermediate portion and communicates with the intermediate portion, a peripheral edge of the intermediate portion and a peripheral edge of the second fixing slot are coincident, the backlight module is disposed in the second fixing slot, the display panel is disposed in the first fixing slot, and the display panel and a bottom surface of the edge portion are fixedly connected.

In an embodiment of the present disclosure, the display panel and the edge portion are fixedly connected by a black adhesive.

In an embodiment of the present disclosure, the cover plate and the display panel are fixedly connected by an optical adhesive.

An embodiment of the present disclosure further provides a a mobile terminal. The mobile terminal includes a middle frame, a display module, and a cover plate. The middle frame includes a first placement slot and a second placement slot. The first placement slot includes an intermediate area and two end areas positioned at two ends of the intermediate area, the second placement slot is positioned below the intermediate area and communicates with the intermediate area, a peripheral edge of the intermediate area and a peripheral edge of the second placement slot are coincident. The display module is disposed in the second placement slot. The cover plate is disposed in the first placement slot. The display module includes a fixing frame, a backlight module, and a display panel, and the backlight module and the display panel are both disposed in the fixing frame. The fixing frame includes opposite first sidewalls, an extending direction of the first sidewalls is perpendicular to an extending direction of the two end areas, and the first sidewalls each include an upper surface facing the cover plate. Two sides of the cover plate and the upper surface are fixedly connected.

In an embodiment of the present disclosure, the upper surface and bottom surfaces of the two end areas of the first placement slot are flush.

In an embodiment of the present disclosure, the upper surface and the bottom surfaces of the two end areas define a connecting surface, and a peripheral edge portion of the cover plate is fixedly connected to the connecting surface by a foam adhesive.

In an embodiment of the present disclosure, a width of each of the first sidewalls ranges between 0.4 mm and 0.5 mm.

In an embodiment of the present disclosure, the first sidewalls each are further provided with a support strip with rigidity, and an extending direction of the support strip is same with the extending direction of the first sidewalls.

In an embodiment of the present disclosure, the fixing frame further includes opposite second sidewalls, an extending direction of the second sidewalls is parallel to an extending direction of the two end areas, and a width of each of the second sidewalls is less than a width of each of the first sidewalls.

In an embodiment of the present disclosure, the second sidewalls are positioned at a level lower than or equal to a level of the bottom surfaces of the two end areas.

In an embodiment of the present disclosure, the fixing frame includes a first fixing slot and a second fixing slot, the first fixing slot includes an intermediate portion and an edge portion positioned around the intermediate portion, the second fixing slot is positioned below the intermediate portion and communicates with the intermediate portion, a peripheral edge of the intermediate portion and a peripheral edge of the second fixing slot are coincident, the backlight module is disposed in the second fixing slot, the display panel is disposed in the first fixing slot, and the display panel and a bottom surface of the edge portion are fixedly connected.

In an embodiment of the present disclosure, the display panel and the edge portion are fixedly connected by a black adhesive.

In an embodiment of the present disclosure, the cover plate and the display panel are fixedly connected by an optical adhesive.

Compared with the mobile terminal of the prior art, the mobile terminal of the embodiment of the present disclosure replaces a connection design of the steps on two sides of the cover plate and the middle frame in the prior art by fixedly connecting the upper surface of each of the first sidewalls of the fixing frame and two side edges of the cover plate. This improves a screen ratio of the mobile terminal and solves the technical problem that current mobile phones have a relatively small screen ratio.

### DESCRIPTION OF DRAWINGS

The accompanying figures to be used in the description of embodiments of the present disclosure or prior art will be described in brief to more clearly illustrate the technical solutions of the embodiments or the prior art. The accompanying figures described below are only part of the embodiments of the present disclosure, from which figures those skilled in the art can derive further figures without making any inventive efforts.

FIG. 1 is a schematic structural diagram of a current mobile phone.

FIG. 2 is a schematic top plan view of a mobile terminal according to an embodiment of the present disclosure.

FIG. 3 is a schematic cross-sectional view taken along line AA of FIG. 2.

FIG. 4 is a schematic cross-sectional view taken along line BB of FIG. 2.

FIG. 5 is a structural explosion diagram of FIG. 3.

FIG. 6 is a schematic structural diagram of a mobile terminal removing a cover plate according to an embodiment of the present disclosure.

FIG. 7 is an enlarged view of C in FIG. 6.

FIG. 8 is a schematic structural diagram of a middle frame of a mobile terminal according to an embodiment of the present disclosure.

### DETAILED DESCRIPTION OF PREFERRED EMBODIMENTS

In the drawings, same component is labeled with same reference number. The following description is based on the specific embodiments of the present disclosure as illustrated, and it should not be construed as limiting other specific embodiments that are not described herein.

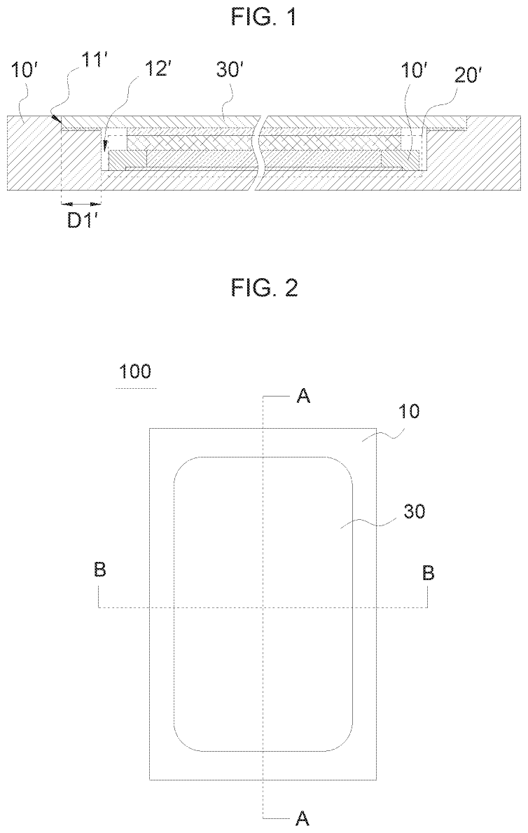

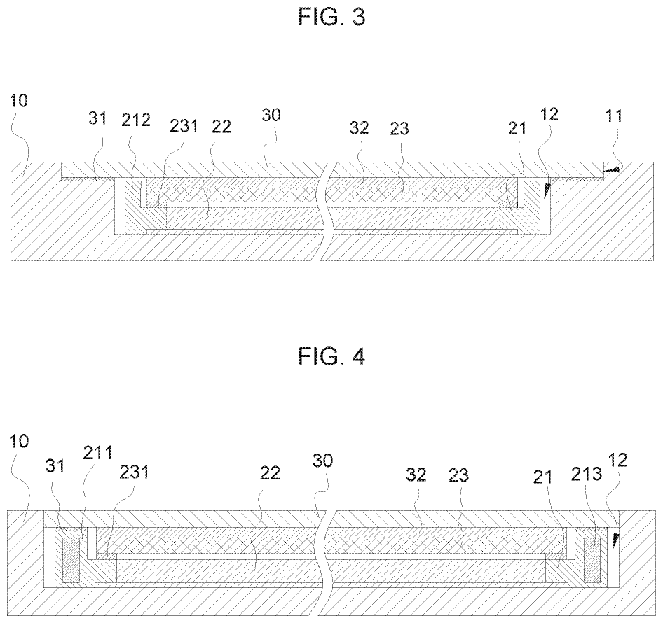

Referring to FIG. 2 to FIG. 5 and FIG. 8, a mobile terminal 100 of an embodiment of the present disclosure includes a middle frame 10, a display module 20, and a cover plate 30.

The middle frame 10 includes a first placement slot 11 and a second placement slot 12. The first placement slot 11 includes an intermediate area 111 and two end areas 112 positioned at two ends of the intermediate area 111. The second placement slot 12 is positioned below the intermediate area 111 and communicates with the intermediate area 111. A peripheral edge of the intermediate area 111 and a peripheral edge of the second placement slot 12 are coincident. The display module 20 is disposed in the second placement slot 12. The cover plate 30 is disposed in the first placement slot 11.

The display module 20 includes a fixing frame 21, a backlight module 22, and a display panel 23. The backlight module 22 and the display panel 23 are both disposed in the fixing frame 21.

The fixing frame 21 includes opposite first sidewalls 211. An extending direction of the first sidewalls 211 is perpendicular to an extending direction of the two end areas 112. The first sidewalls 211 each include an upper surface 21a facing the cover plate 30. Two sides of the cover plate 30 and the upper surface 21a are fixedly connected. The cover plate 30 and the display panel 23 are fixedly connected by an optical adhesive 32.

The mobile terminal 100 of the embodiment replaces a connection design of the steps on two sides of the cover plate and the middle frame in the prior art by fixedly connecting the upper surface 21a of each of the first sidewalls 211 of the fixing frame 21 and two side edges of the cover plate 30. This improves a screen ratio of the mobile terminal 100.

In the embodiment, the intermediate area 111 of the first placement slot 11 is entirely recessed downward, and the recessed portion thereof forms the second placement slot 12. Therefore, the steps on both sides of the middle frame in the prior art are eliminated, and the two side edges of the cover plate have no supporting objects due to the elimination of both sides of the steps. Therefore, the first side walls 211 of the fixing frame 21 extend in a direction of the cover plate 30 to support both side edges of the cover plate 30.

In addition, a width of each of the steps on both sides of the middle frame in the prior art ranges between 6 mm and 8 mm, and a width of each of the first sidewalls 211 in the embodiment ranges between 0.4 mm and 0.5 mm. Therefore, at least a width of the display panel 23 can be increased by 1 mm or more, thereby increasing a screen ratio of the embodiment. It is understood that, in practice, the width of each of the first sidewalls 211 of the fixing frame 21 can be adjusted according to actual conditions.

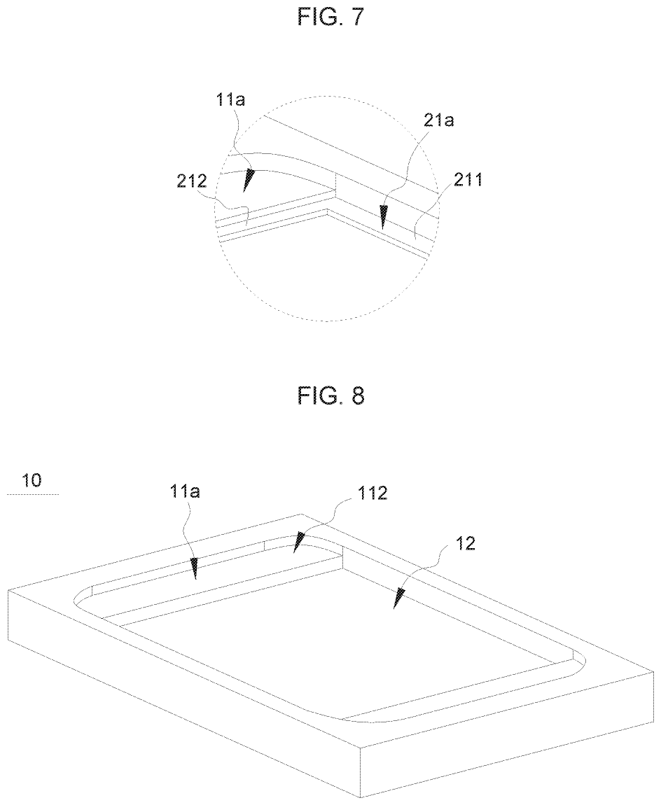

Referring to FIG. 6 and FIG. 7, in the embodiment, the upper surface 21a of each of the first sidewalls 211 and bottom surfaces 11a of the two end areas 112 of the first placement slot 11 are flush. Such an arrangement prevents an unevenness of the cover plate 30 when the cover plate 30 is connected to the upper surface 21a and the bottom surfaces 11a.

In the embodiment, the upper surface 21a and the bottom surfaces 11a of the two end areas 112 define a connecting surface. A peripheral edge portion of the cover plate 30 is fixedly connected to the connecting surface by a foam adhesive 31. Because the upper surface 21a and the bottom surfaces 11a are flush planes, fitting of the cover plate 30 and the connecting surface is facilitated, and a flatness of the cover plate 30 is improved.

In the embodiment, the first sidewalls 211 each are further provided with a support strip 213 with rigidity. An extending direction of the support strip 213 is same with the extending direction of the first sidewalls 211. In the embodiment, the fixing frame 21 is a plastic frame. Therefore, an arrangement of the support strips 213 improves rigidity and supportability of the first sidewalls 211, such that the first sidewalls 211 are sufficient to support the cover plate 30, and a deformation of the first sidewalls 211 is prevented from causing an unevenness of the upper surface 21a.

In the embodiment, the fixing frame 21 further includes opposite second sidewalls 212. An extending direction of the second sidewalls 212 is parallel to an extending direction of the two end areas 112. A width of each of the second sidewalls 212 is less than a width of each of the first sidewalls 211. Because the cover plate 30 and the bottom surfaces 11a of the two end areas 112 are fixedly connected, the cover plate 30 has a sufficient fixed area and a support area, such that the second sidewalls 212 can reduce the connection area with the cover plate 30, even without being fixedly connected to the cover plate 30. That is, the second sidewalls 212 are positioned at a level lower than or equal to a level of the bottom surfaces 11a of the two end areas 112. This can save material and thus save the cost.

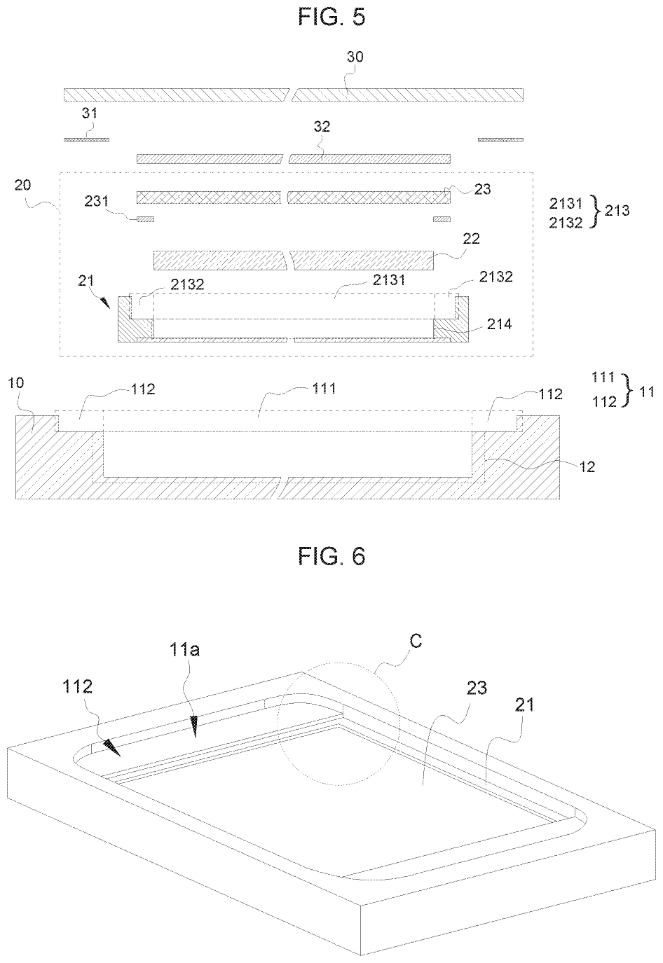

Referring to FIG. 5, in the embodiment, the fixing frame 21 includes a first fixing slot 213 and a second fixing slot 214. The first fixing slot 213 includes an intermediate portion 2131 and an edge portion 2132 positioned around the intermediate portion 2131. The second fixing slot 214 is positioned below the intermediate portion 2131 and communicates with the intermediate portion 2131. A peripheral edge of the intermediate portion 2131 and a peripheral edge of the second fixing slot 214 are coincident.

The backlight module 22 is disposed in the second fixing slot 214. The display panel 23 is disposed in the first fixing slot 213. The display panel 23 and a bottom surface of the edge portion 2132 are fixedly connected.

In the embodiment, the display panel 23 and the edge portion 2132 are fixedly connected by a black adhesive 231. The black adhesive 231 is a black shading glue to prevent the display module 20 from leaking light.

The assembly process of the embodiment is as follows.

First, the first sidewalls 211 and the second sidewalls 212 are closed to form the first fixing slot 213 and the second fixing slot 214, and the backlight module 22 is placed and fixed in the second fixing slot 214 of the fixing frame 21. The display panel 23 is placed in the first fixing slot 213, and is fixedly connected to the bottom surface of the edge portion 2132 by the black adhesive 231 to form the display module 20.

Then, the display module 20 is placed and fixed in the second placement slot 12 of the middle frame 10. Then, the upper surface 21a of each of the first sidewalls 211 of the fixing frame 21 and the bottom surfaces 11a of the two end areas 112 form the connection surface. The foam adhesive 31 is then adhered to the connection surface.

Finally, the cover plate 30 is placed in the first placement slot 11 and attached to the foam adhesive 31 to securely attach the cover plate 30 to the connection surface.

This completes the assembly process of the embodiment.

Compared with the mobile terminal of the prior art, the mobile terminal of the embodiment of the present disclosure replaces a connection design of the steps on two sides of the cover plate and the middle frame in the prior art by fixedly connecting the upper surface of each of the first sidewalls of the fixing frame and two side edges of the cover plate. This improves a screen ratio of the mobile terminal and solves the technical problem that current mobile phones have a relatively small screen ratio.

In summary, various changes and modifications can be made in accordance with the technical solutions and technical concepts of the present disclosure, and these changes and modifications should be encompassed within the protection scope of the present disclosure.

What is claimed is:

1. A mobile terminal, comprising:
a middle frame comprising a first placement slot and a second placement slot, wherein the first placement slot comprises an intermediate area and two end areas positioned at two ends of the intermediate area, the second placement slot is positioned below the intermediate area and communicates with the intermediate area, a peripheral edge of the intermediate area and a peripheral edge of the second placement slot are coincident;
a display module disposed in the second placement slot; and
a cover plate disposed in the first placement slot;
wherein the display module comprises a fixing frame, a backlight module, and a display panel, and the backlight module and the display panel are both disposed in the fixing frame;
wherein the fixing frame comprises opposite first sidewalls, an extending direction of the first sidewalls is perpendicular to an extending direction of the two end areas, and the first sidewalls each comprise an upper surface facing the cover plate;
wherein two sides of the cover plate and the upper surface are fixedly connected;
wherein the upper surface and bottom surfaces of the two end areas of the first placement slot are flush; and
wherein the first sidewalls each are further provided with a support strip with rigidity, and an extending direction of the support strip is same with the extending direction of the first sidewalls.

2. The mobile terminal according to claim 1, wherein the upper surface and the bottom surfaces of the two end areas define a connecting surface, and a peripheral edge portion of the cover plate is fixedly connected to the connecting surface by a foam adhesive.

3. The mobile terminal according to claim 1, wherein a width of each of the first sidewalls ranges between 0.4 mm and 0.5 mm.

4. The mobile terminal according to claim 1, wherein the fixing frame further comprises opposite second sidewalls, an extending direction of the second sidewalls is parallel to an extending direction of the two end areas, and a width of each of the second sidewalls is less than a width of each of the first sidewalls.

5. The mobile terminal according to claim 4, wherein the second sidewalls are positioned at a level lower than or equal to a level of the bottom surfaces of the two end areas.

6. The mobile terminal according to claim 1, wherein the fixing frame comprises a first fixing slot and a second fixing slot, the first fixing slot comprises an intermediate portion and an edge portion positioned around the intermediate portion, the second fixing slot is positioned below the intermediate portion and communicates with the intermediate portion, a peripheral edge of the intermediate portion and a peripheral edge of the second fixing slot are coincident, the backlight module is disposed in the second fixing slot, the display panel is disposed in the first fixing slot, and the display panel and a bottom surface of the edge portion are fixedly connected.

7. The mobile terminal according to claim 6, wherein the display panel and the edge portion are fixedly connected by a black adhesive.

8. The mobile terminal according to claim 1, wherein the cover plate and the display panel are fixedly connected by an optical adhesive.

9. A mobile terminal, comprising:
a middle frame comprising a first placement slot and a second placement slot, wherein the first placement slot comprises an intermediate area and two end areas positioned at two ends of the intermediate area, the second placement slot is positioned below the intermediate area and communicates with the intermediate area, a peripheral edge of the intermediate area and a peripheral edge of the second placement slot are coincident;
a display module disposed in the second placement slot; and
a cover plate disposed in the first placement slot;
wherein the display module comprises a fixing frame, a backlight module, and a display panel, and the backlight module and the display panel are both disposed in the fixing frame;
wherein the fixing frame comprises opposite first sidewalls, an extending direction of the first sidewalls is perpendicular to an extending direction of the two end areas, and the first sidewalls each comprise an upper surface facing the cover plate; and
wherein two sides of the cover plate and the upper surface are fixedly connected.

10. The mobile terminal according to claim 9, wherein the upper surface and bottom surfaces of the two end areas of the first placement slot are flush.

11. The mobile terminal according to claim 10, wherein the upper surface and the bottom surfaces of the two end areas define a connecting surface, and a peripheral edge portion of the cover plate is fixedly connected to the connecting surface by a foam adhesive.

12. The mobile terminal according to claim 9, wherein a width of each of the first sidewalls ranges between 0.4 mm and 0.5 mm.

13. The mobile terminal according to claim 9, wherein the first sidewalls each are further provided with a support strip with rigidity, and an extending direction of the support strip is same with the extending direction of the first sidewalls.

14. The mobile terminal according to claim 9, wherein the fixing frame further comprises opposite second sidewalls, an extending direction of the second sidewalls is parallel to an extending direction of the two end areas, and a width of each of the second sidewalls is less than a width of each of the first sidewalls.

15. The mobile terminal according to claim 14, wherein the second sidewalls are positioned at a level lower than or equal to a level of the bottom surfaces of the two end areas.

16. The mobile terminal according to claim 9, wherein the fixing frame comprises a first fixing slot and a second fixing slot, the first fixing slot comprises an intermediate portion and an edge portion positioned around the intermediate portion, the second fixing slot is positioned below the intermediate portion and communicates with the intermediate portion, a peripheral edge of the intermediate portion and a peripheral edge of the second fixing slot are coincident, the backlight module is disposed in the second fixing slot, the display panel is disposed in the first fixing slot, and the display panel and a bottom surface of the edge portion are fixedly connected.

17. The mobile terminal according to claim 16, wherein the display panel and the edge portion are fixedly connected by a black adhesive.

18. The mobile terminal according to claim 9, wherein the cover plate and the display panel are fixedly connected by an optical adhesive.
